(19) United States
(12) Patent Application Publication
(10) Pub. No.: US 2005/0134534 A1
(43) Pub. Date: Jun. 23, 2005

(54) Flat-panel display device, display drive circuite and display drive method

(76) Inventors: Satoshi Yamada, Kodama-gun (JP); Tsutomu Sakamoto, Minato-ku (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/049,997

(22) Filed: Feb. 4, 2005

Related U.S. Application Data
(63) Continuation of application No. PCT/JP03/11576, filed on Sep. 10, 2003.

(30) Foreign Application Priority Data
Sep. 13, 2003 (JP) 2002-268271

(51) Int. Cl. G09G 3/28

(52) U.S. Cl. 345/63

(57) ABSTRACT

A flat-panel display device includes scan lines, signal lines, pixels arrayed at intersections of the scan lines and signal lines and having a surface-conduction electron-emitter, a video processing circuit, a scan line driver, and a signal line driver. The video processing circuit includes a video analysis unit that divides a video signal for one horizontal line into a predetermined number of blocks and obtains average levels of the video signal blocks, a correction coefficient calculation unit that determines correction coefficients for the blocks, which match with voltage drops due to wiring resistance of the scan lines, on the basis of the average levels of the video signal blocks that are obtained by the video analysis unit, and a video signal correction unit that multiplies each video signal block by the associated correction coefficient determined by the correction coefficient calculation unit.

### CROSS-REFERENCE TO RELATED APPLICATIONS

This is a Continuation Application of PCT Application No. PCT/JP03/11576, filed Sep. 10, 2003, which was published under PCT Article 21(2) in Japanese.

This application is based upon and claims the benefit of priority from prior Japanese Patent Application No. 2002-268271, filed Sep. 13, 2002, the entire contents of which are incorporated herein by reference.

### BACKGROUND OF THE INVENTION

1. Field of the Invention

The present invention relates to a flat-panel display device such as a field emission display (FED) whose pixels are formed using, e.g., surface-conduction electron-emitters, and also to a display drive circuit and a display drive method for the flat-panel display device.

2. Description of the Related Art

An FED generally comprises a display panel and a drive circuit for driving the display panel. The display panel includes a plurality of scan lines that extend in a width (horizontal) direction, a plurality of signal lines that extend in a height (vertical) direction to intersect the scan lines, and a plurality of pixels that are arrayed at intersections between the scan lines and the signal lines. In the display panel for color display, three adjacent pixels in the horizontal direction, for instance, are used as a color pixel. Each pixel is composed of a surface-conduction electron-emitter and a red (R), green (G) or blue (B) phosphor that is caused to emit light by an electron beam emanating from the electron-emitter.

The drive circuit includes a Y-driver that is connected to one end of each scan line, and an X-driver that is connected to one end of each signal line. The Y-driver successively drives the scan lines using a scan signal. While each scan line is being driven, the X-driver drives the signal lines using drive signals each having a pulse width corresponding to a video signal. Each pixel emits light with a luminance corresponding to a pixel voltage between the associated signal line and scan line.

In the meantime, each scan line has a wiring resistance, and a voltage drop that varies in accordance with the distance from the Y-driver occurs in each scan line. For example, even if the pixels of one horizontal line are driven by the same drive signals, these pixels cannot emit light with a uniform luminance distribution. The effective pixel voltage is higher in a pixel that is located closer to the Y-driver, and is lower in a pixel that is located farther from the Y-driver.

In recent years, the majority of display panels have an aspect ratio of width:height=16:9. In the case of this screen size, a number of pixels are connected to each scan line, and thus the influence of wiring resistance is not negligible in the scan line. For example, in the case where the number of color pixels is width:height=1280:720, 1280×3 (RGB) surface-conduction electron-emitters are connected commonly to each scan line. In this case, a potential difference of at least 2 to 3V occurs between both ends of the scan line due to a voltage drop resulting from wiring resistance. This increases a difference in pixel voltage between the pixels of one horizontal line, makes the luminance distribution of pixels non-uniform, and considerably degrades the display quality.

### BRIEF SUMMARY OF THE INVENTION

The object of the present invention is to provide a flat-panel display device, a display drive circuit and a display drive method, which can prevent non-uniformity in pixel luminance due to wiring resistance.

According to the present invention, there is provided a flat-panel display device comprising: a plurality of scan lines; a plurality of signal lines intersecting the scan lines; a plurality of pixels arrayed at intersections of the scan lines and the signal lines and each driven in accordance with a voltage between a pair of the scan line and signal line; a video processing circuit that processes a video signal; a scan line driver that successively drives the scan lines; and a signal line driver that drives the signal lines on the basis of the video signal from the video processing circuit while each of the scan lines is driven by the scan line driver, wherein the video processing circuit includes a video analysis unit that divides the video signal for one horizontal line into a predetermined number of blocks and obtains average levels of the video signal blocks; a correction coefficient calculation unit that determines correction coefficients for the blocks, which match with voltage drops caused due to wiring resistance of the scan lines, on the basis of the average levels of the video signal blocks obtained by the video analysis unit; and a video signal correction unit that multiplies each video signal block by the associated correction coefficient which is determined by the correction coefficient calculation unit.

According to the invention, there is provided a display drive circuit for a display panel which comprises a plurality of scan lines, a plurality of signal lines intersecting the scan lines, and a plurality of pixels arrayed at intersections of the scan lines and the signal lines and each driven in accordance with a voltage between a pair of the scan line and signal line, the display drive circuit comprising: a video processing circuit that processes a video signal; a scan line driver that successively drives the scan lines; and a signal line driver that drives the signal lines on the basis of a video signal from the video processing circuit while each of the scan lines is driven by the scan line driver; wherein the video processing circuit includes a video analysis unit that divides the video signal for one horizontal line into a predetermined number of blocks and obtains average levels of the video signal blocks; a correction coefficient calculation unit that determines correction coefficients for the blocks, which match with voltage drops caused due to wiring resistance of the scan lines, on the basis of the average levels of the video signal blocks obtained by the video analysis unit; and a video signal correction unit that multiplies each video signal block by the associated correction coefficient which is determined by the correction coefficient calculation unit.

According to the invention, there is provided a display drive method for a display panel which comprises a plurality of scan lines, a plurality of signal lines intersecting the scan lines, and a plurality of pixels arrayed at intersections of the scan lines and the signal lines and each driven in accordance with a voltage between a pair of the scan line and signal line, the method comprising: executing a video process including a process of dividing the video signal for one horizontal line into a predetermined number of blocks to obtain average levels of the video signal blocks, determining correction coefficients for the blocks, which match with voltage drops caused due to wiring resistance of the scan lines, on the basis of the average levels, and multiplying each video signal block by the associated correction coefficient; successively driving the scan lines; and driving the signal lines on the basis of the video signal resulting from the video process while each of the scan lines is driven.

With the plat-panel display device, display drive circuit and display drive method, a video signal for one horizontal line is divided into a predetermined number of blocks, and average levels of the video signal are obtained for the blocks. Correction coefficients, which match with voltage drops for the blocks caused due to wiring resistance of the scan lines, are determined on the basis of the average levels, and the video signal for each block is multiplied by the associated correction coefficient. It is thus possible to prevent the pixel luminance from becoming non-uniform due to the wiring resistance.

### BRIEF DESCRIPTION OF THE SEVERAL VIEWS OF THE DRAWING

FIG. 1 schematically shows the circuit configuration of a plat-panel display device according to an embodiment of the present invention;

FIG. 2 is a timing chart for explaining the operation of the flat-panel display device shown in FIG. 1;

FIG. 3 shows an equivalent circuit of a display panel shown in FIG. 1;

FIG. 4A to FIG. 4C are graphs for explaining a luminance gradient that occurs in each horizontal line of pixels in FIG. 3;

FIG. 5 shows an example of an image that is displayed on the display panel shown in FIG. 1;

FIG. 6A to FIG. 6C are graphs for explaining a luminance difference that occurs between two horizontal lines shown in FIG. 5;

FIG. 7 shows the circuit configuration of a correction circuit shown in FIG. 1;

FIG. 8 shows blocks of a video signal, which are divided by a signal analysis circuit shown in FIG. 7;

FIG. 9 is a graph showing correction coefficients that are determined for the blocks of the video signal shown in FIG. 8;

FIG. 10A to FIG. 10C are graphs for explaining correction that is executed by the correction circuit shown in FIG. 7 with respect to the luminance gradient of each horizontal line;

FIG. 11 is a graph showing the voltage-luminance characteristic of a surface-conduction electron-emitter shown in FIG. 1; and

FIG. 12 shows graphs for explaining correction that is executed by the correction circuit shown in FIG. 7 with respect to the luminance difference between horizontal lines.

### DETAILED DESCRIPTION OF THE INVENTION

A flat-panel display device according to an embodiment of the present invention will now be described with reference to the accompanying drawings. This flat-panel display device is a field emission display (FED) that has, for example, a 720P High-Vision XGA resolution with the number of color pixels being width (horizontal):height (vertical)=1280:720.

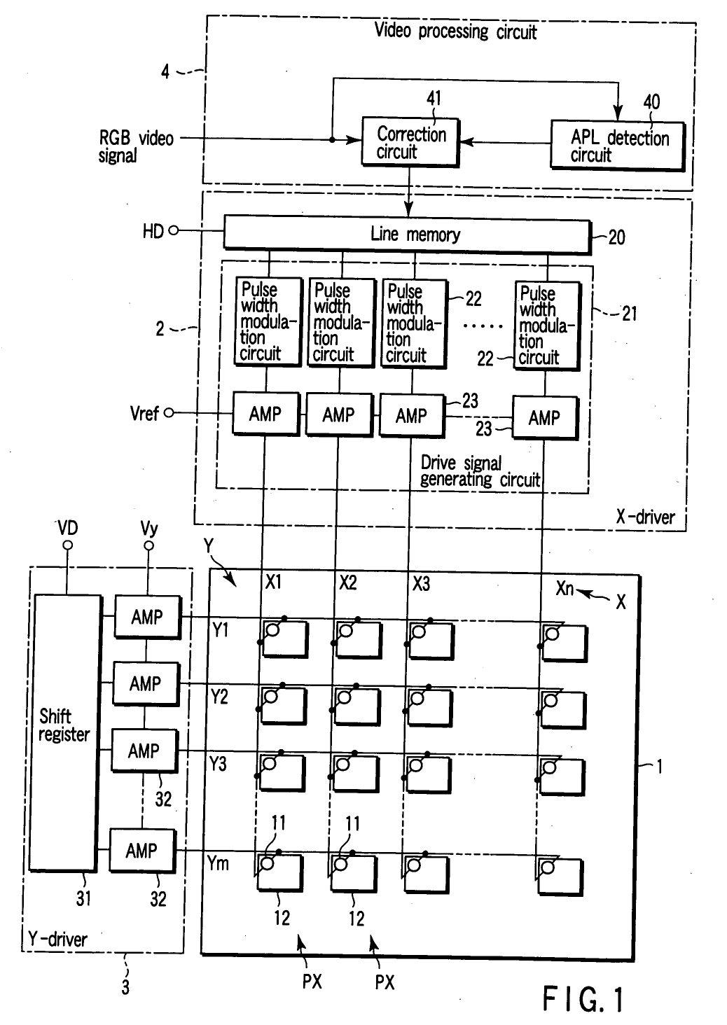

FIG. 1 schematically shows the circuit configuration of the flat-panel display device. The flat-panel display device comprises a display panel 1, an X-driver 2, a Y-driver 3 and a video processing circuit 4. The display panel includes an m (=720) number of scan lines (Y1-Ym) that extend in the width (horizontal) direction, an n (=1280×3) number of signal lines X (X1-Xn) that extend in the height (vertical) direction, crossing the scan lines Y1 to Ym, and m×n (=about 2,760,000) pixels PX that are arrayed at intersections of scan lines Y1 to Ym and signal lines X1 to Xn. Each of color pixels is composed of three adjacent pixels PX in the horizontal direction. In the color pixel, the three pixels PX comprise surface-conduction electron-emitters 11 and red (R), green (G) and blue (B) phosphors 12 that are caused to emit light by electron beams emanating from the surface-conduction electron-emitters 11, respectively. Each scan line Y is used as a scan electrode that is connected to the electron-emitters 11 of the pixels PX of the associated horizontal line. Each signal line X is used as a signal electrode that is connected to the electron-emitters 11 of the pixels PX of the associated vertical line.

The X-driver 2, Y-driver 3 and video processing circuit 4 are used as a drive circuit for the display panel 1 and are disposed on a peripheral region of the display panel 1. The X-driver 2 is connected to one end of each of the signal lines X1 to Xn, and the Y-driver 3 is connected to one end of each of the scan lines Y1 to Ym. The video processing circuit 4 digitally processes an RGB video signal that is supplied from an external signal source. The Y-driver 3 successively drives the scan lines Y1 to Ym using a scan signal. While each of the scan lines Y1 to Ym is driven, the X-driver 2 drives the signal lines X1 to Xn using drive signals. The video processing circuit 4 includes an APL detection unit 40 and a correction circuit 41. The APL detection unit 40 totals the RGB video signal for one frame to detect an average level. Based on the detection result of the APL detection unit 40, the correction circuit 41 corrects the RGB video signal in each horizontal scan period, and outputs the corrected video signal to the X-driver 2. In addition, the APL detection unit 40 may be configured to detect at least one of an average level of the RGB video signal for one or more frames and an average level of the RGB video signal for one or more horizontal lines. Further, the APL detection unit 40 may be modified such that the average level of the video signal for one or more frames is detected from light-emission currents or discharge currents actually flowing in the pixels, or such that the average level of the video signal for one or more horizontal lines is detected from light-emission currents or discharge currents actually flowing in the pixels.

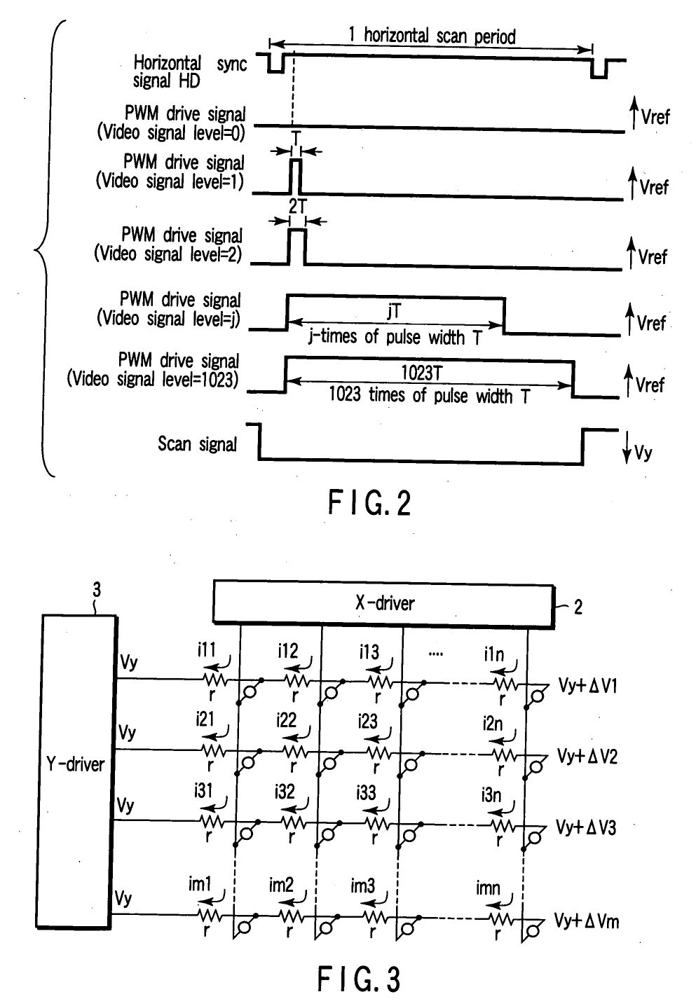

The X-driver 2 includes a line memory 20 and a drive signal generating circuit 21. The line memory 20 samples and holds the video signal for one horizontal line, which is supplied from the video processing circuit 4, in synchronism with a horizontal sync signal HD. The drive signal generating circuit 21 generates an n-number of PWM drive signals according to the video signal for one horizontal line, which is output in parallel from the line memory 20. The drive signal generating circuit 21 includes an n-number of pulse width modulation circuits 22 and an n-number of output buffers 23. The pulse width modulation circuits 22 generate pulse signals whose pulse widths are proportional to the video signal levels for the associated pixels. The output buffers 23 output a voltage Vref from a driving reference voltage terminal, as drive signals, to the signal lines X1 to Xn for time periods that are equal to the pulse widths of the pulse signals from the pulse width modulation circuits 22. Specifically, as shown in FIG. 2, the drive signal is a voltage Vref that is output with a pulse width corresponding to the video signal level. Consider a case where the pulse width modulation circuit 22 sets pulse widths of 1024 gradations from a 0th gradation that corresponds to the minimum level of the video signal, to a 1023rd gradation that corresponds to the maximum level of the video signal. In this case, as shown in FIG. 2, the pulse width of the drive signal is set at 0 for the 0th gradation, set at T for the first gradation, and set at T×j for the jth gradation. T is preset to be equal to, e.g. 1/1023 of an effective video period included in the one horizontal scan period, so that the pulse width of the drive signal does not exceed the one horizontal scan period even when the video signal takes the maximum level of the 1023rd gradation.

The Y-driver 3 includes a shift register 31 and an m-number of output buffers 32. The shift register 31 shifts a vertical sync signal VD for each horizontal scan period to output the shifted vertical sync signal VD from one of an m-number of output terminals. Each output buffer 32 responds to a pulse from a corresponding one of the m-number of output terminals and output a voltage Vyon from a scan voltage terminal, as a scan signal, to a corresponding one of the scan lines Y1 to Ym for one horizontal scan period. Specifically, as shown in FIG. 2, the scan signal is a negative voltage Vyon that is output only in one horizontal scan period. In each electron-emitter 11, discharge occurs when a voltage Vref+Vyon between the signal electrode and the scan electrode exceeds a threshold. Thereby, an electron beam is emitted to excite the phosphor 12.

Next, a description is given to the circuit characteristics in the absence of the video processing circuit 4. FIG. 3 shows an equivalent circuit of the display panel 1 shown in FIG. 1. In the equivalent circuit, symbol r denotes a wiring resistance that is distributed in each of the scan lines Y1 to Yn. Symbols ill to imn designate light-emission currents that flow when an (m×n) number of surface-conduction electron-emitters 11 are discharged. Symbol Vy designates an output terminal voltage of the Y-driver 3, and each of ΔV1 to ΔVm indicates a sum of voltage drop that occurs when the light-emission current flows via the wiring resistance of a corresponding one of the scan lines Y1 to Yn, at the time of discharge of the n-number of surface-conduction electron-emitters 11.

The values ΔV1, ΔV2, ΔV3, . . . , ΔVm are expressed by:
ΔV1=r×i11+2×r×i12+ . . . +n×r×i1n,
ΔV2=r×i21+2×r×i22+ . . . +n>r×i2n,
ΔV3=r×i31+2×r×i32+ . . . +n×r×i3n,
ΔVm=r×im1+2×r×im2+ . . . +n×r×imn.

When the pixels PX of one horizontal line are driven via the signal lines X1 to Xn, light-emission currents flow in the electron-emitters 11 of the pixels PX, except for those in a black display state. All the light-emission currents flow to the Y-driver 3 via the associated scan line Y. Specifically, if the maximum current of each pixel PX is 500 μA, the sum of currents is 1.92 A.

As the position of the pixel PX is farther from the Y-driver 3, the pixel PX is more affected by the voltage drop, ΔV1 to ΔVm, that varies depending on the wiring resistance and light-emission current. In the case where the entire wiring resistance of each scan line Y is 4 Ω, if the voltage drop is simply calculated by current (1.92 A) X wiring resistance (4 Ω), the value of the voltage drop is 7.68V. In fact, the wiring resistance and current are distributed, and the voltage drop becomes about 2V. Such a voltage drop decreases the pixel voltage that is applied to the surface-conduction electron-emitter 11, and makes it impossible to exhibit the normal light-emission performance.

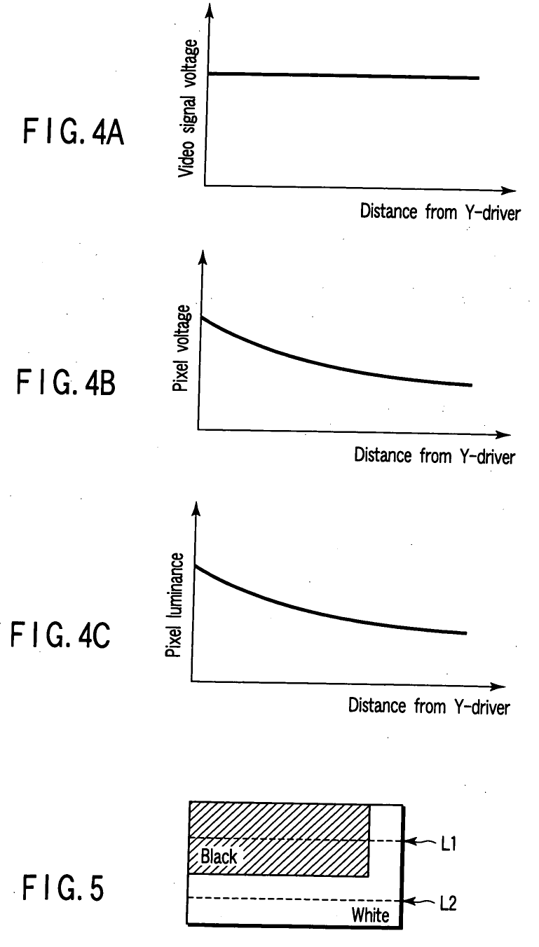

In the case where, as shown in FIG. 4A, the video signal has a maximum level maintained with respect to the pixels PX of one horizontal line, the pixel voltage becomes lowest at the pixel PX that is farthest from the Y-driver 3, as shown in FIG. 4B, due to the voltage drop caused by the wiring resistance. Thus, a luminance gradient, as shown in FIG. 4C, occurs in the horizontal line of the pixels PX. This luminance gradient would be decreased, for example, if the maximum level of the video signal is lowered to restrict the light-emission current. In this case, however, the entire screen would disadvantageously be darkened.

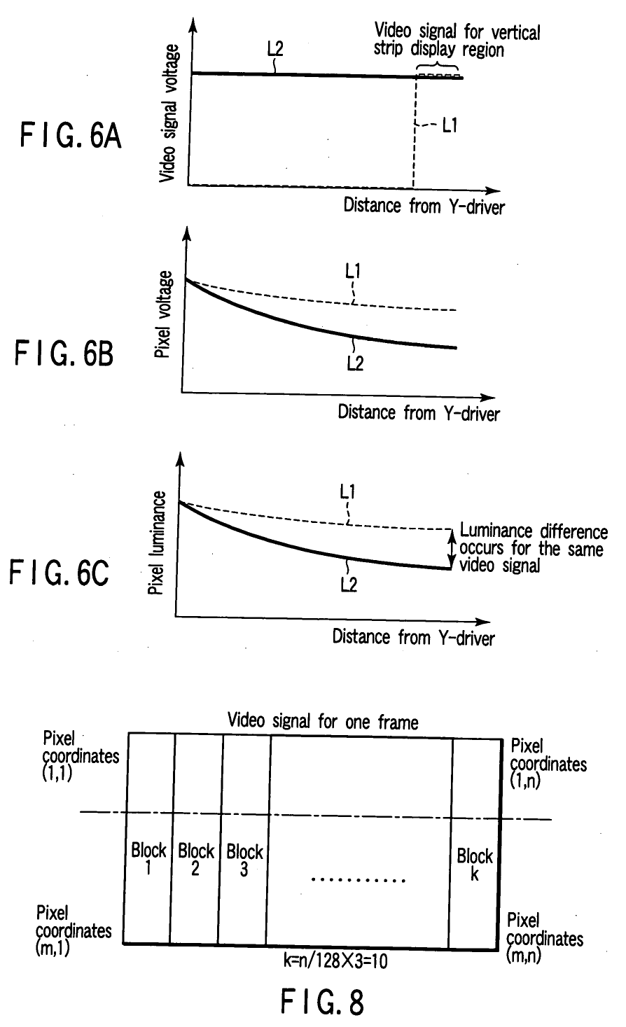

In a case where an image shown in FIG. 5 is displayed so as to compare a horizontal line L1 of pixels PX and a horizontal line L2 of pixels PX, parts of the video signal that are indicated by a broken line and a solid line in FIG. 6A are input with respect to the horizontal lines L1 and L2, respectively. If the pixels PX of the horizontal lines L1 and L2 are driven according to the associated parts of the video signal, the number of light-emission pixels differs between the horizontal line L1 and horizontal line L2. Consequently, a light-emission current and a voltage drop varying depending on the light-emission current become different between the horizontal lines L1 and L2. As a result, the pixel voltage is distributed as shown in FIG. 6B, and the pixel luminance is distributed as shown in FIG. 6C. A pixel voltage difference and a pixel luminance difference between the horizontal lines L1 and L2 become greater as the distance from the Y-driver 3 increases. For example, in a white vertical strip display region that is located on the right side of the display screen, all horizontal lines have to effect white display with an equal-level luminance. However, crosstalk occurs as a phenomenon that a horizontal stripe appears on the screen in accordance with a luminance difference occurring between the horizontal lines.

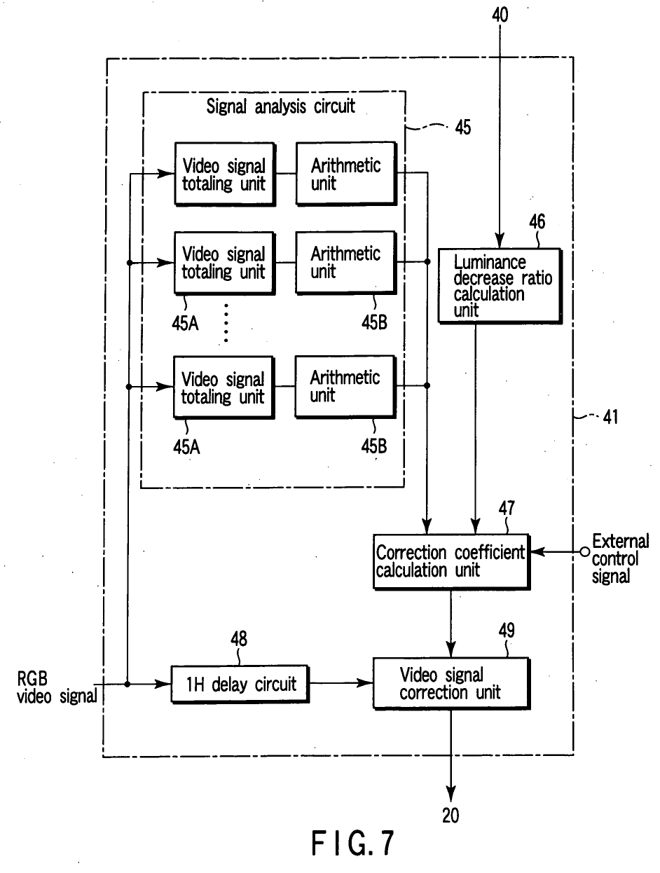

The video processing circuit 4 shown in FIG. 1 is configured to correct a video signal for one horizontal line such that the same pixel voltages are obtained when the video signal is constant. For this purpose, the correction circuit 41 of the video processing circuit 4 comprises, as shown in FIG. 7, a signal analysis circuit 45, a luminance decrease ratio calculation unit 46, a correction coefficient calculation unit 47, a 1H delay circuit 48 and a video signal correction unit 49.

The signal analysis circuit 45 divides a video signal for one horizontal line, which is supplied in each one horizontal scan period, into, e.g. k blocks, as shown in FIG. 8, and analyzes the video signal blocks blocks. In the case where the number of pixels in one horizontal line is n=3840, if the number of pixels in each block is set at 128×3, the number of blocks is k=n/128×3=10. The signal analysis circuit 45 includes a k-number of video signal totaling unit 45A and a k-number of arithmetic units 45B. Each video signal totaling unit 45A totals the video signal of the associated one of the different blocks to obtain an average level. The arithmetic units 45B execute arithmetic processing to multiply the average levels, which are obtained by the video signal totaling units 45A, by different coefficients.

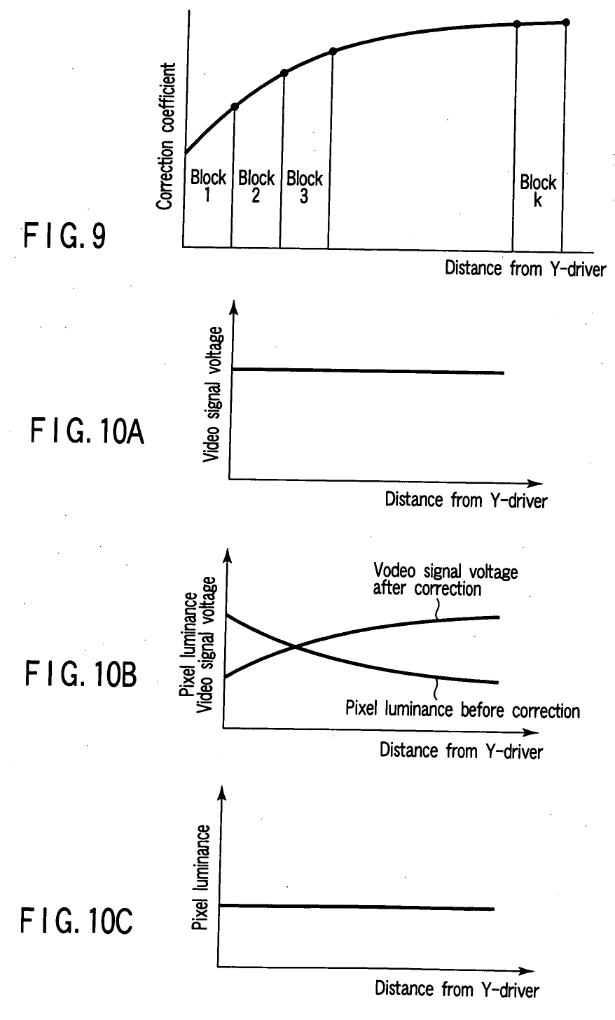

The correction coefficient calculation unit 47 determines correction coefficients for the video signal blocks, which match with voltage drops due to the wiring resistance of the scan lines Y, on the basis of arithmetic results that are obtained by the arithmetic units 45B for the respective blocks. As is shown in FIG. 9, assuming that the video signal level varies linearly in the respective blocks, the correction coefficients are set at values indicated by black dots indicated at boundaries of the blocks.

The luminance decrease ratio calculation unit 46 determines a maximum luminance decrease ratio on the basis of the average level of the video signal, which is obtained from the APL detection circuit 40, and uniformly adjusts the correction coefficients that are determined by the correction coefficient calculation unit 47 so as to obtain the degree of correction that corresponds to the maximum luminance decrease ratio. In addition, the correction coefficients may be adjusted to obtain a desired correction degree by an external control signal that is supplied to an auxiliary control terminal provided on the correction coefficient calculation unit 47, as shown in FIG. 7. This adjustment is executed in preference to the luminance decrease ratio calculation unit 46. Specifically, the correction coefficients that are determined for the respective blocks by the correction coefficient calculation unit 47 are uniformly adjusted by a correction coefficient adjusting unit that comprises the luminance decrease ratio calculation unit 46, APL detection circuit 40 and the control terminal for the external control signal.

The 1H delay circuit 48 delays the RGB video signal by one horizontal scan period, and outputs the delayed RGB video signal to the video signal correction unit 49. While the video signals are being delayed by the 1H delay circuit 48, the signal analysis circuit 45, luminance decrease ratio calculation unit 46 and correction coefficient calculation unit 47 executes their processes. The video signal correction unit 49 multiplies the video signal for one horizontal line, which is output from the 1H delay circuit 48, by the correction coefficients that are obtained from the correction coefficient calculation unit 47, and the outputs the resultant signal to the line memory 20 of the X-driver 2.

In short, the correction circuit 41 analyzes the level of the video signal for one horizontal line, and varies in advance the video signal so as to reduce the luminance gradient in one horizontal line and the luminance difference between adjacent horizontal lines due to wiring resistance of the scan lines Y.

The correction operation for the luminance gradient in one horizontal line is described in greater detail.

Consider a case where the video signal is maintained at the maximum level for all pixels PX of one horizontal line, as shown in FIG. 10A. In this case, as shown in FIG. 10B, the pixel luminance of the pixel PX becomes lower as the pixel PX is positioned farther from the Y-driver 3, since a voltage drop occurs due to the wiring resistance of the scan line Y. To deal with this problem, the video signal correction unit 49 corrects the video signal for one horizontal line, as shown in FIG. 10B. Thus, even if a voltage drop occurs in the scan line Y, the actual pixel luminance becomes constant regardless of the distance from the Y-driver 3, as shown in FIG. 10C.

Next, the operation of correcting the difference in luminance between adjacent horizontal lines is described.

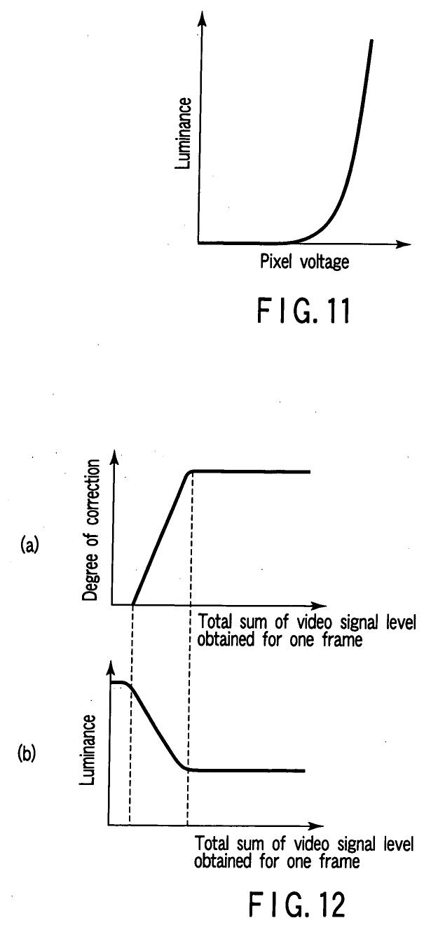

As described above, as the pixel PX is positioned farther from the Y-driver 3, the pixel luminance thereof decreases. Hence, a maximum luminance decrease radio may be set in order to uniformly lower the video signal level, thereby making the luminance of pixels in one frame, other than the darkest pixel, conform to the luminance of this darkest pixel. Thus, the difference in luminance between the adjacent horizontal lines can be eliminated. However, if correction is always executed in this manner, all image patterns would be darkened at the same ratio. For example, a bright image pattern has a large luminance decrease and a large luminance difference occurs on the screen. Thus, the correction of luminance is always necessary. On the other hand, a dark image pattern has a less luminance decrease than the bright image pattern, and a luminance difference is less visible. The surface-conduction electron-emitter 11 has voltage-luminance characteristics as shown in FIG. 11. Thus, the effect of luminance variation is small, relative to a voltage variation in the dark image pattern. Therefore, the correction is not necessarily required.

If the area of a high-luminance part is large, the amount of light-emission current is large and a voltage drop increases. Thus, the degree of luminance decrease is large, and the correction is required.

However, if the area of a high-luminance part is small, the light-emission current, which flows at the time of discharge of the electron-emitter 11, is small and a voltage drop is small. Thus, the degree of luminance decrease is small, and correction is not required.

In summary, in the dark image pattern or the pattern with the small area of high-luminance part, the light-emission current is small and the voltage drop due to wiring resistance is small. Thus, on the screen, the luminance decrease is small and the luminance gradient and crosstalk are less visible. On the other hand, in the bright image pattern or the pattern with the large area of high-luminance part, the light-emission current is large and the voltage drop due to wiring resistance is large. Thus, on the screen, the luminance decrease is large and the luminance gradient and crosstalk are more visible.

In other words, correction is unnecessary in the dark image pattern or the pattern with the small area of high-luminance part, and correction is necessary in the bright image pattern or the pattern with the large area of high-luminance part.

For the above reason, in the correction of the luminance difference between the adjacent horizontal lines, the maximum luminance decrease ratio is determined by the luminance decrease ratio calculation unit 46 on the basis of the average level of video signals of one frame that varies depending on the kind of image pattern, and the correction coefficients that are determined by the correction coefficient calculation unit 47 are adjusted in the correction coefficient calculation unit 47 on the basis of the maximum luminance decrease ratio. As a result, as shown in part (a) of FIG. 12, in the dark image pattern or the image pattern with the small area of high-luminance part, no correction is executed. In an intermediate-level image pattern, correction is executed not at 100% but with such a certain degree that the correction is not easily recognizable. Complete correction is executed in the bright image pattern or the image pattern with the large area of high-luminance part. Part (b) of FIG. 12 indicates a luminance in the case where the video signals are made common and the white display area is made variable.

Thereby, the luminance of an image pattern with a large degree of luminance decrease, such as a bright image pattern or an image pattern with a large area of high-luminance part, can be adjusted without decreasing the luminance of an image pattern, the luminance of which needs to be set at a high level, such as a dark image pattern or an image pattern with a small area of high-luminance pattern.

In addition, since the degree of correction for decreasing the luminance can be adjusted by an external control signal, it is possible to obtain characteristics such as those of an ABL circuit, which uniformly decreases the luminance of an image pattern with a large area of high-luminance part in order to protect, in general, CRT displays and increase the life of CRT displays.

According to the flat-panel display device of the above-described embodiment, a video signal for one horizontal line is divided into a predetermined number of blocks, and average levels are obtained for the video signal blocks. Further, correction coefficients for the blocks, which match with voltage drops due to wiring resistance of the scan lines Y, are determined on the basis of the average levels. The video signal blocks are multiplied by the associated correction coefficients. Thereby, a luminance gradient, with which the pixel luminance becomes non-uniform due to wiring resistance, can be prevented. In addition, luminance correction can selectively be executed for the image pattern in which the luminance decrease on the screen is large and the luminance gradient or crosstalk is highly visible. Moreover, the luminance correction method can properly be altered in accordance with the type of image patterns obtained from video signals. Therefore, high-quality images can be obtained without needlessly lowering the luminance.

The above-described embodiment adopts the stripe arrangement in which three pixels PX that constitute a color image are linearly arranged in the horizontal direction. The invention is also effective for a delta arrangement. The invention is applicable not only to the scheme wherein the Y-driver 3 is disposed on only one side of the scan lines Y1 to Ym, but also to a scheme wherein two Y-drivers are disposed on both sides of the scan lines Y1 to Ym if a voltage drop due to wiring resistance occurs depending on the distance from the Y-driver 3.

As has been described above, the present invention may provide a flat-panel display device that can prevent non-uniformity in pixel luminance due to wiring resistance.

The present invention is usable in order to prevent non-uniformity in pixel luminance due to wiring resistance in a flat-panel display device, such as a field emission display (FED), wherein a plurality of pixels are formed using, e.g. surface-conduction electron-emitters.

1. A flat-panel display device comprising:
a plurality of scan lines;
a plurality of signal lines intersecting the scan lines;
a plurality of pixels arrayed at intersections of the scan lines and the signal lines and each driven in accordance with a voltage between a pair of the scan line and signal line;
a video processing circuit that processes a video signal;
a scan line driver that successively drives the scan lines; and
a signal line driver that drives the signal lines on the basis of the video signal from the video processing circuit while each of the scan lines is driven by the scan line driver,
wherein the video processing circuit includes a video analysis unit that divides the video signal for one horizontal line into a predetermined number of blocks and obtains average levels of the video signal blocks; a correction coefficient calculation unit that determines correction coefficients for the blocks, which match with voltage drops caused due to wiring resistance of the scan lines, on the basis of the average levels of the video signal blocks obtained by the video analysis unit; and a video signal correction unit that multiplies each video signal block by the associated correction coefficient which is determined by the correction coefficient calculation unit.

2. The flat-panel display device according to claim 1, wherein the pixel includes a surface-conduction electron-emitter that emits an electron beam.

3. The flat-panel display device according to claim 1, wherein the video processing circuit further includes a correction coefficient adjusting unit that uniformly adjusts the correction coefficients that are determined for the respective blocks by the correction coefficient calculation unit.

4. The flat-panel display device according to claim 3, wherein the correction coefficient adjusting unit includes a detection unit that detects at least one of an average level of the video signal for one or more frames and an average level of the video signal for one or more horizontal lines, and a maximum luminance decrease ratio calculation unit that determines a maximum luminance decrease ratio for uniformly adjusting the correction coefficients on the basis of a detection result of the detection unit.

5. The flat-panel display device according to claim 4, wherein the detection unit is configured to detect the average level of the video signal for one or more frames on the basis of currents that actually flow in the pixels.

6. The flat-panel display device according to claim 4, wherein the detection unit is configured to detect the average level of the video signal for one or more horizontal lines on the basis of currents that actually flow in the pixels.

7. The flat-panel display device according to claim 3, wherein the correction coefficient adjusting unit is configured to uniformly adjust the correction coefficients on the basis of an external control signal.

8. A display drive circuit for a display panel which comprises a plurality of scan lines, a plurality of signal lines intersecting the scan lines, and a plurality of pixels arrayed at intersections of the scan lines and the signal lines and each driven in accordance with a voltage between a pair of the scan line and signal line, the display drive circuit comprising:
a video processing circuit that processes a video signal;
a scan line driver that successively drives the scan lines; and
a signal line driver that drives the signal lines on the basis of a video signal from the video processing circuit while each of the scan lines is driven by the scan line driver;
wherein the video processing circuit includes a video analysis unit that divides the video signal for one horizontal line into a predetermined number of blocks and obtains average levels of the video signal blocks; a correction coefficient calculation unit that determines correction coefficients for the blocks, which match with voltage drops caused due to wiring resistance of the scan lines, on the basis of the average levels of the video signal blocks obtained by the video analysis unit; and a video signal correction unit that multiplies each video signal block by the associated correction coefficient which is determined by the correction coefficient calculation unit.

9. The display drive circuit according to claim 8, wherein the pixel includes a surface-conduction electron-emitter that emits an electron beam.

10. The display drive circuit according to claim 8, wherein the video processing circuit further includes a correction coefficient adjusting unit that uniformly adjusts the correction coefficients that are determined for the respective blocks by the correction coefficient calculation unit.

11. The display drive circuit according to claim 10, wherein the correction coefficient adjusting unit includes a detection unit that detects at least one of an average level of the video signal for one or more frames and an average level of the video signal for one or more horizontal lines, and a maximum luminance decrease ratio calculation unit that determines a maximum luminance decrease ratio for uniformly adjusting the correction coefficients on the basis of a detection result of the detection unit.

12. The display drive circuit according to claim 11, wherein the detection unit is configured to detect the average level of the video signal for one or more frames on the basis of currents that actually flow in the plurality of pixels.

13. The display drive circuit according to claim 11, wherein the detection unit is configured to detect the average level of the video signal for one or more horizontal lines on the basis of currents that actually flow in the plurality of pixels.

14. The display drive circuit according to claim 10, wherein the correction coefficient adjusting unit is configured to uniformly adjust the correction coefficients on the basis of an external control signal.

15. A display drive method for a display panel comprising a plurality of scan lines, a plurality of signal lines intersecting the scan lines, and a plurality of pixels arrayed at intersections of the scan lines and the signal lines and each driven in accordance with a voltage between a pair of the scan line and signal line, the method comprising:
executing a video process including a process of dividing the video signal for one horizontal line into a predetermined number of blocks to obtain average levels of the video signal blocks, determining correction coefficients for the blocks, which match with voltage drops due to wiring resistance of the scan lines, on the basis of the average levels, and multiplying each video signal block by the associated correction coefficient;
successively driving the scan lines; and
driving the signal lines on the basis of the video signal resulting from the video process while each of the scan lines is driven.

16. The display drive method according to claim 15, wherein the pixel includes a surface-conduction electron-emitter that emits an electron beam.

17. The display drive method according to claim 15, wherein the video process further includes a process of uniformly adjusting the correction coefficients that are determined for the respective blocks.

18. The display drive method according to claim 17, wherein the process of adjusting the correction coefficients includes a process of detecting at least one of an average level of the video signal for one or more frames and an average level of the video signal for one or more horizontal lines, and determining a maximum luminance decrease ratio for uniformly adjusting the correction coefficients on the basis of a result of the detection.

19. The display drive method according to claim 18, wherein the average level of the video signal for one or more frames is detected on the basis of currents that actually flow in the pixels.

20. The display drive method according to claim 18, wherein the average level of the video signal for one or more horizontal lines is detected on the basis of currents that actually flow in the pixels.

21. The display drive method according to claim 17, wherein the correction coefficients are uniformly adjusted on the basis of an external control signal.
